(19) United States
(12) Patent Application Publication
(10) Pub. No.: US 2026/0333026 A1
(43) Pub. Date: Oct. 22, 2026

(54) UPDATING SENSING PARAMETERS BASED ON PRIVACY CRITERIA

(71) Applicant: Lenovo (United States) Inc., Morrisville, NC (US)

(72) Inventors: Andreas Kunz, Ladenburg (DE); Sheeba Backia Mary Baskaran, Friedrichsdorf (DE)

(73) Assignee: Lenovo (United States) Inc., Morrisville, NC (US)

(21) Appl. No.: 19/532,808

(22) Filed: Feb. 6, 2026

(51) Int. Cl. H04W 12/02

(52) U.S. Cl. CPC H04W 12/02

(57) ABSTRACT

Various aspects of the present disclosure relate to updating sensing parameters based on privacy criteria. A first network entity (NE) may obtain a request to trigger a sensing operation associated with a sensing target. The request includes one or more parameters associated with a sensing accuracy of the sensing operation. The first NE may output the request to a second NE with an update to the parameters to satisfy a privacy criteria associated with the sensing target. The privacy criteria indicates a threshold value associated with the sensing accuracy. The first NE may obtain one or more sensing measurements associated with the sensing target based on the update to the parameters. In some cases, the second NE may perform the sensing operation based on the update to the parameters to obtain the sensing measurements, and may output the sensing measurements and an indication that the privacy criteria are satisfied.

### TECHNICAL FIELD

The present disclosure relates to wireless communications, and more specifically to sensing operations.

### BACKGROUND

A wireless communications system may include one or multiple network communication devices, which may be otherwise known as network entities (NEs), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies, including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NEs), processors, and methods of the present disclosure each have several innovative aspects, no single one of which is solely responsible for the desirable features disclosed herein.

A first NE (e.g., a sensing function) for wireless communication is described. The first NE may be configured to, capable of, or operable to perform one or more operations as described herein. For example, the first NE may be configured to, capable of, or operable to obtain (e.g., receive, retrieve) a request to trigger a sensing operation associated with a sensing target, where the request includes one or more parameters associated with a sensing accuracy of the sensing operation, output (e.g., transmit, send, forward) to a second NE, the request with an update to the one or more parameters to satisfy a privacy criteria associated with the sensing target, where the privacy criteria indicates a threshold value associated with the sensing accuracy, and obtain (e.g., receive, retrieve), based on the update to the one or more parameters, one or more sensing measurements associated with the sensing target.

A processor (e.g., a standalone processor chipset, or a component of an NE) for wireless communication is described. The processor may be configured to, capable of, or operable to perform one or more operations as described herein. For example, the processor may be configured to, capable of, or operable to obtain a request to trigger a sensing operation associated with a sensing target, where the request includes one or more parameters associated with a sensing accuracy of the sensing operation, output, to a second NE, the request with an update to the one or more parameters to satisfy a privacy criteria associated with the sensing target, where the privacy criteria indicates a threshold value associated with the sensing accuracy, and obtain, based on the update to the one or more parameters, one or more sensing measurements associated with the sensing target.

A method performed or performable by a first NE (e.g., a sensing function) for wireless communication is described. The method may include obtaining a request to trigger a sensing operation associated with a sensing target, where the request includes one or more parameters associated with a sensing accuracy of the sensing operation, outputting, to a second NE, the request with an update to the one or more parameters to satisfy a privacy criteria associated with the sensing target, where the privacy criteria indicates a threshold value associated with the sensing accuracy, and obtaining, based on the update to the one or more parameters, one or more sensing measurements associated with the sensing target.

In some implementations of the first NE, the processor, and the method described herein, the first NE, the processor, and the method may further be configured to, capable of, or operable to obtain (e.g., receive, retrieve, access), from at least one of a local data storage associated with the first NE or an external data storage accessible by the first NE, the privacy criteria, where the privacy criteria are associated with at least one of a sensing area associated with the sensing target or a device associated with the sensing target, and where the request indicates the at least one of the sensing area or the device. In some implementations, the one or more parameters include a sensing accuracy parameter, and the first NE, the processor, and the method may further be configured to, capable of, or operable to modify (e.g., adjust, update, change) the sensing accuracy parameter from a first accuracy value to a second accuracy value that is lower than the first accuracy value, where the update to the one or more parameters includes the second accuracy value. In some implementations, the first accuracy value corresponds to a first resolution that enables identification of a type of the sensing target, and the second accuracy value corresponds to a second resolution that disables identification of the type of the sensing target.

In some implementations, the request includes a sensing target blueprint indicating a pattern of scattering points associated with the sensing target, and the first NE, the processor, and the method may further be configured to, capable of, or operable to determine (e.g., identify, ascertain, detect) that the sensing target blueprint is associated with a sensing accuracy value that fails to satisfy the threshold value prior to updating the one or more parameters, and modify (e.g., adjust, update, change) the sensing target blueprint, where the sensing accuracy value satisfies the threshold value based on modifying the sensing target blueprint, and where the one or more parameters include at least one of the pattern of the scattering points or the sensing accuracy value. In some implementations, the first NE, the processor, and the method may further be configured to, capable of, or operable to determine (e.g., identify, ascertain, detect), based on the update to the one or more parameters, that the one or more sensing measurements satisfy the privacy criteria, and output (e.g., transmit, send, forward) to a third NE, and based on the one or more sensing measurements satisfying the privacy criteria, the one or more sensing measurements and an indication that the privacy criteria are satisfied, where the third NE includes a network exposure function (NEF).

In some implementations, the first NE, the processor, and the method may further be configured to, capable of, or operable to obtain (e.g., receive, retrieve), from a third NE, an additional request to trigger an additional sensing operation associated with an additional sensing target, where the third NE includes an NEF, and output (e.g., transmit, send, forward) to the third NE, an indication that the additional request is rejected based on additional privacy criteria associated with the additional sensing target. In some implementations, the privacy criteria are associated with a geographic area defined by at least one of an antenna tilt range associated with the second NE or an angular range associated with the second NE. In some implementations, the privacy criteria are based on one or more of a user consent associated with the sensing target, a geographic location associated with the sensing target, one or more legal policies associated with the sensing target, one or more operator policies associated with the sensing target, or a timing associated with the sensing operation. In some implementations, the first NE includes a sensing function, and the second NE includes a sensing entity.

A first NE (e.g., a sensing entity) for wireless communication is described. The first NE may be configured to, capable of, or operable to perform one or more operations as described herein. For example, the first NE may be configured to, capable of, or operable to obtain (e.g., receive, retrieve) a request to trigger a sensing operation associated with a sensing target, where the request includes one or more parameters associated with a sensing accuracy of the sensing operation, perform (e.g., execute, carry out, conduct), based on an update to the one or more parameters, the sensing operation to obtain (e.g., receive, retrieve) one or more sensing measurements, where the update to the one or more parameters satisfies a privacy criteria associated with the sensing target, and where the privacy criteria indicates a threshold value associated with the sensing accuracy, and output (e.g., transmit, send, forward), based on the request, the one or more sensing measurements and an indication that the privacy criteria are satisfied.

A processor (e.g., a standalone processor chipset, or a component of an NE) for wireless communication is described. The processor may be configured to, capable of, or operable to perform one or more operations as described herein. For example, the processor may be configured to, capable of, or operable to obtain a request to trigger a sensing operation associated with a sensing target, where the request includes one or more parameters associated with a sensing accuracy of the sensing operation, perform, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy, and output, based on the request, the one or more sensing measurements and an indication that the privacy criteria are satisfied.

A method performed or performable by a first NE (e.g., a sensing entity) for wireless communication is described. The method may include obtaining a request to trigger a sensing operation associated with a sensing target, where the request includes one or more parameters associated with a sensing accuracy of the sensing operation, performing, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy, and outputting, based on the request, the one or more sensing measurements and an indication that the privacy criteria are satisfied.

In some implementations of the first NE, the processor, and the method described herein, the first NE, the processor, and the method may further be configured to, capable of, or operable to obtain (e.g., receive, retrieve), from at least one of a local data storage associated with the first NE or an external data storage accessible by the first NE, the privacy criteria, where the privacy criteria are associated with a sensing area associated with the sensing target. In some implementations, the one or more parameters include a sensing accuracy parameter, and the first NE, the processor, and the method may further be configured to, capable of, or operable to modify (e.g., adjust, update, change) the sensing accuracy parameter from a first accuracy value to a second accuracy value that is lower than the first accuracy value, where the update to the one or more parameters includes the second accuracy value. In some implementations, the first accuracy value corresponds to a first resolution that enables identification of a type of the sensing target, and the second accuracy value corresponds to a second resolution that disables identification of the type of the sensing target.

In some implementations, the request includes a sensing target blueprint indicating a pattern of scattering points associated with the sensing target, and the first NE, the processor, and the method may further be configured to, capable of, or operable to determine (e.g., identify, ascertain, detect) that the sensing target blueprint is associated with a sensing accuracy value that fails to satisfy the threshold value prior to updating the one or more parameters, and modify (e.g., adjust, update, change) the sensing target blueprint, where the sensing accuracy value satisfies the threshold value based on modifying the sensing target blueprint. In some implementations, the first NE, the processor, and the method may further be configured to, capable of, or operable to obtain (e.g., receive, retrieve) an additional request to trigger an additional sensing operation associated with an additional sensing target, and output (e.g., transmit, send, forward) an additional indication that the additional request is rejected based on additional privacy criteria associated with the additional sensing target.

In some implementations, the privacy criteria are associated with a geographic area defined by at least one of an antenna tilt range associated with the first NE or an angular range associated with the first NE. In some implementations, the privacy criteria are based on one or more of a user consent associated with the sensing target, a geographic location associated with the sensing target, one or more legal policies associated with the sensing target, one or more operator policies associated with the sensing target, or a timing associated with the sensing operation, and the first NE includes a sensing entity.

### BRIEF DESCRIPTION OF THE DRAWINGS

FIGS. 1 and 2 illustrate examples of wireless communications systems in accordance with aspects of the present disclosure.

FIGS. 3 and 4 illustrate examples of sensing diagrams, in accordance with aspects of the present disclosure.

FIGS. 5 and 6 illustrate example signaling diagrams, in accordance with aspects of the present disclosure.

FIG. 7 illustrates an example of an NE (e.g., a sensing function and/or a sensing entity) in accordance with aspects of the present disclosure.

FIG. 8 illustrates an example of a processor in accordance with aspects of the present disclosure.

FIG. 9 illustrates a flowchart of a method performed by an NE (e.g., a sensing function) in accordance with aspects of the present disclosure.

FIG. 10 illustrates a flowchart of a method performed by an NE (e.g., a sensing entity) in accordance with aspects of the present disclosure.

### DETAILED DESCRIPTION

In a wireless communications system, one or more NEs, including a sensing entity (e.g., a base station, a gNB) and a sensing function, may support sensing operations. For example, the sensing entity transmits signals and receives reflections of the signals from sensing targets (e.g., an object, a human, an animal, a vehicle) within a sensing area to detect, identify, or track the sensing targets using characteristics of the reflected signal. In some cases, a sensing service consumer (e.g., an application function or an application server) may send a request to the sensing function that triggers the sensing operation. The request may include one or more parameters for the sensing operation, such as an accuracy parameter, a latency parameter, and/or a resolution parameter, as well as a sensing target blueprint indicating a pattern of scattering points that define a sensing target. The sensing function may forward the request to the sensing entity, which performs the sensing operation within a sensing area according to the parameters. The sensing entity may measure the reflected signal and transmit the measurements to the sensing function. The sensing function may process the measurements to determine whether the reflected signal characteristics correspond to the pattern of scattering points indicated by the sensing target blueprint, enabling detection or identification of the sensing targets. The sensing function may transmit the results of the sensing operation (e.g., sensing data that indicates detection, identification, or tracking information related to the sensing targets) to the sensing service consumer.

In some cases, the NEs in the wireless communications system (e.g., the sensing entity, the sensing function, and/or the sensing service consumer, among other NEs) may access the sensing data related to sensing targets without considering privacy criteria for the sensing data. For example, the NEs may not receive approval from the sensing target to collect the sensing data, and the sensing targets may be unaware that the NEs are collecting the sensing data. The sensing data may enable identification of a type of the sensing target in privacy-restricted geographic regions, such as private residences or government buildings, among other examples. The NEs may distribute and/or disclose the sensing data, which may include privacy-sensitive information (e.g., information indicating a location of the sensing target, information indicating a type or identity of the sensing target, information indicating a movement pattern or trajectory of the sensing target, or information indicating physical characteristics of the sensing target), to entities that are not authorized to access the sensing data. Distributing or disclosing the sensing data to unauthorized entities leads to a violation of the privacy criteria for the sensing data.

As described herein, to enable one or more NEs to perform a sensing operation that does not violate a privacy of sensing data obtained from the sensing operation, an NE (e.g., a sensing function and/or a sensing entity) may update one or more parameters that define a sensing accuracy of a sensing operation to satisfy a privacy criteria for a sensing target. The NE may obtain a request to trigger the sensing operation, where the request includes the parameters (e.g., a sensing accuracy parameter, a resolution parameter) and may include a sensing target blueprint indicating a pattern of scattering points that characterize the sensing target. The NE may obtain the privacy criteria from a local data storage at the NE or an external data storage accessible by the NE, where the privacy criteria are configured for a sensing area or a device that is the sensing target. The privacy criteria may indicate a threshold value, such as a maximum sensing accuracy, and the NE may determine that a sensing accuracy value in the request fails to satisfy the threshold value. The NE may modify the sensing accuracy parameter from a first accuracy value (e.g., an accuracy value that enables identification of a type of the sensing target) to a second accuracy value that is lower than the first accuracy value (e.g., an accuracy value that disables identification of the type of the sensing target). The NE may perform the sensing operation using the update to the parameters to obtain sensing measurements with the lower accuracy, and may output the sensing measurements along with an indication that the privacy criteria are satisfied. In some cases, the NE may reject the request if the privacy criteria indicate that the NE is not to collect any sensing data about sensing targets.

By performing the described techniques, a device (e.g., an NE such as a sensing function and/or a sensing entity) in a wireless communications system may provide for improved data privacy, reduced unauthorized data exposure, and improved compliance with privacy policies during sensing operations. For example, an NE may update (e.g., adjust, change, modify) the parameters to satisfy privacy criteria for sensing areas or sensing targets, enabling the wireless communications system to perform sensing operations, while preventing or reducing identification of privacy-sensitive characteristics. For example, a sensing function or a sensing entity may reduce a sensing accuracy parameter from a high accuracy value (e.g., an accuracy value that enables identification of a type of the sensing target, such as distinguishing a human from an animal or a vehicle) to a lower accuracy value (e.g., an accuracy value that disables identification of the type of the sensing target, while enabling detection of the sensing target). The update to the parameters may reduce privacy violations by reducing the granularity (e.g., reducing a resolution and/or accuracy) of sensing data collected for privacy-restricted sensing targets or sensing areas, such as private residences or government buildings, rather than collecting high-resolution sensing data that could reveal privacy-sensitive information.

Reference is made herein to communicating data or information, such as signaling communication resources and/or communications that are transmitted or received between devices or entities. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings, is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

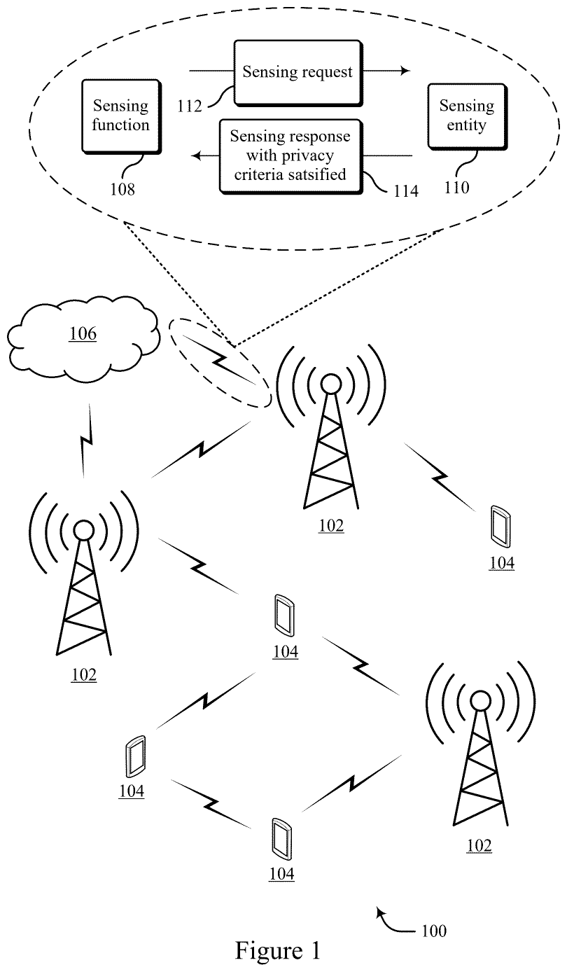

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology, including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be, or include, or may be referred to as a network node, a base station, an access point (AP), a network element, a network function, a network equipment, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include, or may be referred to as, a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or a machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NEs 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access NE, which may be an example of an access node controller (ANC). An ANC may communicate with the one or more UEs 104 through one or more other access network transmission entities, which may be referred to as radio heads, smart radio heads, or transmission-reception points (TRPs).

In some implementations, an NE 102 may be configured in a disaggregated architecture, which may be configured to utilize a protocol stack physically or logically distributed among two or more NEs, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the NEs 102 in a disaggregated RAN architecture may be co-located, or one or more components of the NEs 102 may be located in distributed locations (e.g., separate physical locations). In some implementations, one or more NEs 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective NEs 102 that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management function (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

The wireless communications system 100 may support integrated sensing and communication (ISAC) operations. The ISAC operations combine wireless communication capabilities with sensing capabilities, enabling the wireless communications system 100 to detect, identify, and/or track objects or targets (e.g., sensing targets) using the same radio signals and infrastructure used for communication. For example, the ISAC operations may utilize measurements from one or more NEs 102 (e.g., at a sensing function 108 from one or more sensing entities 110) to detect, identify, and/or track sensing targets within a sensing area. As part of the ISAC operations, the wireless communications system 100 may perform sensing operations that involve transmitting sensing signals and processing reflections of the signals to obtain information about sensing targets. A sensing operation involves a procedure by which the NEs 102 in the wireless communications system 100 detect, measure, or characterize physical phenomena, sensing targets, or environmental conditions using transmitted and received signals.

In some cases, sensing operations may include transmitting a sensing signal from a sensing entity 110, reflecting or scattering the signal off a sensing target, such as an object, a person, an animal, or a vehicle, and receiving the reflected signal at the sensing entity 110 or another device. The sensing entity 110 may measure characteristics of the reflected signal to detect, identify, and/or track sensing targets within a sensing area, where the sensing area defines a geographic region within which the sensing entity 110 may perform sensing operations and detect sensing targets. In some cases, the sensing entity 110 may operate in a mono-static sensing mode, where the sensing entity 110 acts as both a sensing transmitter and a sensing receiver. In the mono-static sensing mode, the sensing entity 110 transmits sensing signals toward sensing targets and receives reflections of the transmitted signals at the same sensing entity 110. In some other cases, the sensing entity 110 may operate in a bi-static sensing mode, where a first sensing entity transmits sensing signals and a second sensing entity receives reflections of the transmitted signals.

The sensing entity 110 may collect one or more measurements, and the sensing entity 110, a sensing function 108, and/or a different NE 102 may determine a location, a velocity, a trajectory, and/or a type of the sensing target utilizing the reflected signal characteristics. A sensing target fulfilling a description in a sensing area and time can be detected, identified, or tracked (e.g., in three-dimensions) using radio signals of the sensing entity 110, such as based on sensing assistance information and sensing contextual information. Sensing assistance information may include information that assists the sensing entity 110 in performing sensing operations, such as timing information, frequency information, beam configuration information, or reference signal configuration information that enables the sensing entity 110 to transmit and receive sensing signals. Sensing contextual information may include information about the environment or context in which sensing operations are performed, such as information about the sensing area, expected sensing targets, environmental conditions, or historical sensing data that provides context for interpreting sensing measurements. The sensing entity 110 may use the sensing assistance information to configure the transmission and reception of sensing signals, and may use the sensing contextual information to interpret the reflected signals and determine characteristics of sensing targets, such as the presence, location, velocity, trajectory, or type of the sensing target within the sensing area.

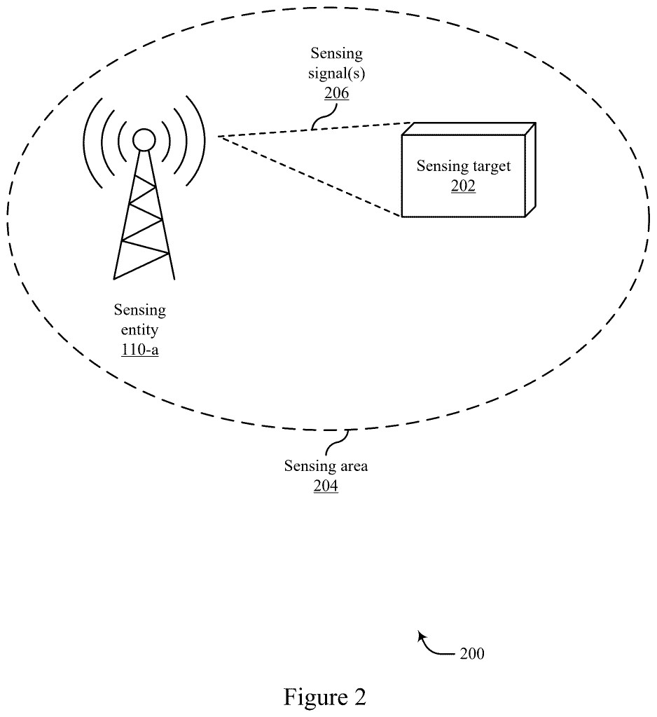

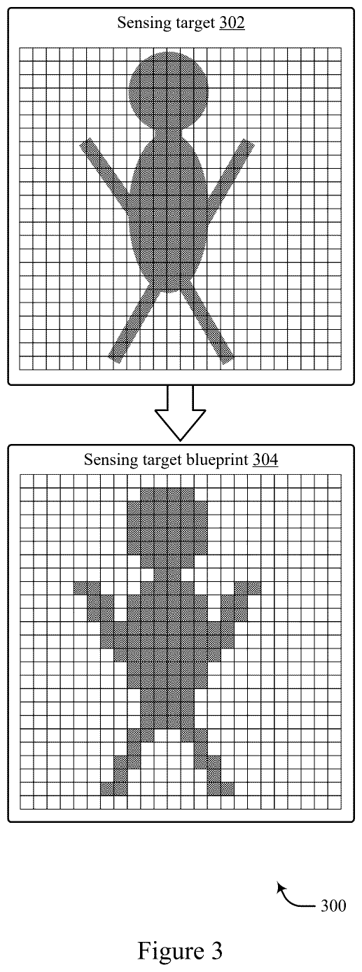

A sensing entity 110 may be an NE 102 (e.g., a base station, a gNB) that performs sensing operations within a sensing area according to a sensing description received in a sensing request. The sensing description defines parameters and characteristics of a sensing operation, including information about sensing targets to be detected. Specifically, the sensing description may include information about a sensing target in terms of reflection points or scattering points, which together form a sensing target blueprint, which is described in further detail with respect to FIGS. 2 and 3. The sensing target blueprint represents a pattern of scattering points that characterize a sensing target, enabling one or more NEs 102 (e.g., the sensing function 108, the sensing entity 110, or one or more different NEs 102) to detect or identify the sensing target based on how sensing signals reflect from the target. For example, a sensing target blueprint for a human may include scattering points arranged in a pattern corresponding to a head, torso, arms, and legs, where each scattering point represents a discrete location on or around the sensing target from which transmitted sensing signals may reflect or scatter back toward the sensing entity 110. The sensing entity 110 may transmit sensing signals toward sensing targets and receive reflections of the sensing signals from the sensing targets. The sensing entity 110 may measure the reflected signals and transmit the measurements to a sensing function 108 for processing.

A sensing function 108 is a logical function that supports sensing services within the wireless communications system 100. The sensing function 108 may include one or more components, such as a sensing control function (SCF) that manages and coordinates sensing operations, a sensing processing function (SPF) that processes sensing measurements to derive sensing results, and a sensing gateway (SG) that provides an interface between the sensing function 108 and other NEs 102 or external entities. The sensing function 108 may receive sensing requests from a sensing service consumer (e.g., an application function or an application server) via an NEF, authorize the sensing requests, select a sensing entity 110 to perform the sensing operation, and process sensing measurements received from the sensing entity 110. The sensing function 108 may determine whether the sensing measurements correspond to a sensing target blueprint indicating a pattern of scattering points that characterize a sensing target, enabling detection or identification of the sensing target.

An NEF is a network function that provides a secure interface for external entities to access network services and capabilities. The sensing service consumer and the NEF may have a security association. The NEF may receive sensing service requests from sensing service consumers, select a sensing function 108 for invoking the sensing service, authorize the request, and forward the sensing information (e.g., including the sensing target blueprint) to the sensing function 108. The NEF may also receive sensing results from the sensing function 108 and forward the results to the sensing service consumer.

A sensing service consumer is an entity that may consume sensing results and may request sensing services, and may be an internal or external application function. The sensing service consumer may send a sensing service request to the NEF with information including a sensing service type (e.g., object detection, object tracking, environment sensing), sensing service criteria (e.g., accuracy, latency, resolution), time information for the sensing service (e.g., time for sensing measurement, time for sensing report), a target sensing service area or a target UE, and/or a sensing target blueprint with a scattering points description for object detection. The sensing service criteria may include a sensing accuracy parameter, among other parameters. The sensing accuracy parameter defines the precision or resolution of sensing measurements, which may be expressed in terms of the size of scattering points (e.g., 5 centimeters by 5 centimeters per scattering point) or other resolution metrics. With high enough sensing accuracy (e.g., a high number of scattering points in the blueprint, such as 5 centimeters by 5 centimeters per scattering point), the sensing service consumer and/or other NEs 102 may distinguish between different sensing targets, such as a cat, a dog, a human, a tree, or a car based on the sensing measurements.

In some cases, the NEs 102 in the wireless communications system 100 (e.g., the sensing entity 110, the sensing function 108, and/or the sensing service consumer, among other NEs 102) may access sensing data related to sensing targets without considering privacy criteria for the sensing data. For example, the NEs 102 may not receive approval from the sensing target to collect the sensing data, and the sensing targets may be unaware that the NEs 102 are collecting the sensing data. The sensing data may enable identification of a type of the sensing target in privacy-restricted geographic regions, such as private residences or government buildings, among other examples. The NEs 102 may distribute and/or disclose the sensing data, which may include privacy-sensitive information (e.g., information indicating a location of the sensing target, information indicating a type or identity of the sensing target, information indicating a movement pattern or trajectory of the sensing target, or information indicating physical characteristics of the sensing target), to entities that are not authorized to access the sensing data. Distributing or disclosing the sensing data to unauthorized entities leads to a violation of the privacy criteria for the sensing data. For example, if a sensing service consumer requests high-accuracy sensing measurements (e.g., 5 centimeters by 5 centimeters per scattering point), then the resulting sensing data may include sufficient detail to distinguish object types, such as humans, animals, or vehicles, which may violate privacy criteria for sensing areas or sensing targets.

According to implementations, one or more of the NEs 102 are operable to implement various aspects of the techniques described with reference to the present disclosure. To enable the NEs 102 to perform a sensing operation that does not violate a privacy of sensing data obtained from the sensing operation, an NE 102 (e.g., the sensing function 108 and/or the sensing entity 110) may update one or more parameters that define a sensing accuracy of a sensing operation to satisfy a privacy criteria for a sensing target. The privacy criteria define requirements, policies, and/or thresholds that govern how sensing data is to be handled to protect the privacy of sensing targets or sensing areas. The privacy criteria may be based on user consent, geographic location, legal policies, operator policies, timing, or other factors. The sensing function 108 or the sensing entity 110 may define or obtain information that defines the privacy criteria for the sensing areas and/or sensing targets utilizing geographic regions, such as by an antenna tilt range (e.g., from 10 degrees to 20 degrees) and/or an angular range of the sensing entity 110. For example, private residences, government buildings, or company facilities may have associated privacy criteria related to sensing operations.

The sensing function 108 may obtain a request to trigger the sensing operation, where the request includes the parameters (e.g., a sensing accuracy parameter, a resolution parameter) and may include a sensing target blueprint indicating a pattern of scattering points that characterize the sensing target. In some examples, the sensing function 108 may perform privacy enforcement by obtaining the privacy criteria from at least one of a local data storage at the sensing function 108 or an external data storage accessible by the sensing function 108, where the privacy criteria are configured for a sensing area or a device that is the sensing target. The privacy criteria may indicate a threshold value, such as a maximum sensing accuracy, and the sensing function 108 may determine that a sensing accuracy value in the request fails to satisfy the threshold value. The sensing function 108 may modify the sensing accuracy parameter from a first accuracy value (e.g., an accuracy value that enables identification of a type of the sensing target) to a second accuracy value that is lower than the first accuracy value (e.g., an accuracy value that disables identification of the type of the sensing target). The sensing function 108 may output the sensing request 112 with the update to the parameters to the sensing entity 110. The sensing entity 110 may perform the sensing operation using the update to the parameters to obtain sensing measurements with the lower accuracy. The sensing entity 110 may output the sensing response with privacy criteria satisfied 114 to the sensing function 108, where the sensing response with privacy criteria satisfied 114 includes the sensing measurements along with an indication that the privacy criteria are satisfied.

In some other examples, the sensing function 108 may forward the sensing request 112 with the original parameters to the sensing entity 110, and the sensing entity 110 may perform the privacy enforcement. The sensing entity 110 may obtain the privacy criteria from at least one of a local data storage at the sensing entity 110 or an external data storage accessible by the sensing entity 110, where the privacy criteria are configured for the sensing area or the device that is the sensing target. The sensing entity 110 may determine that the sensing accuracy value in the request fails to satisfy the threshold value indicated by the privacy criteria. The sensing entity 110 may modify the sensing accuracy parameter from the first accuracy value to the second accuracy value that is lower than the first accuracy value. The sensing entity 110 may perform the sensing operation using the modified parameters to obtain sensing measurements with the lower accuracy, and may output the sensing response with privacy criteria satisfied 114 to the sensing function 108, where the sensing response with privacy criteria satisfied 114 includes the sensing measurements and an indication that the privacy criteria are satisfied. In some cases, the sensing function 108 or the sensing entity 110 may reject the request if the privacy criteria indicate that the NE is not to collect any sensing data about sensing targets.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include a sensing entity 110-a, which may be an example of a sensing entity 110, as described with reference to FIG. 1.

The wireless communications system 200 includes a sensing entity 110-a, a sensing target 202, a sensing area 204, and sensing signals 206. The sensing entity 110-a may be an example of an NE (e.g., a base station, a gNB) that performs sensing operations within the wireless communications system 200. The sensing target 202 represents a sensing target that the sensing entity 110-a may detect, identify, or track using radio signals. The sensing area 204 defines a geographic region within which the sensing entity 110-a may perform sensing operations and detect sensing targets, such as the sensing target 202. The sensing entity 110-a transmits the sensing signals 206 toward the sensing target 202, and the sensing signals 206 may reflect off the sensing target 202 to return to the sensing entity 110-a, enabling the sensing entity 110-a to obtain sensing measurements for the sensing target 202. The sensing measurements may include, for example, signal strength measurements, time-of-arrival measurements, angle-of-arrival measurements, Doppler shift measurements, and/or radar cross-section measurements for the sensing target 202.

The sensing measurements enable one or more NEs to detect, identify, and track the sensing target 202 by analyzing characteristics of the reflected sensing signals 206. For example, signal strength measurements may indicate the presence and size of the sensing target 202, time-of-arrival measurements may enable determination of a distance between the sensing entity 110-a and the sensing target 202, angle-of-arrival measurements may enable determination of a direction of the sensing target 202 relative to the sensing entity 110-a, and Doppler shift measurements may enable determination of a velocity or movement of the sensing target 202. By combining multiple sensing measurements over time, the sensing entity 110-a may track a trajectory of the sensing target 202 as the sensing target 202 moves within the sensing area 204. Additionally, or alternatively, by comparing the sensing measurements to a sensing target blueprint indicating a pattern of scattering points, the NEs may identify a type of the sensing target 202, such as distinguishing between a human, an animal, or a vehicle based on the pattern of reflections received from the sensing target 202.

The sensing entity 110-a transmits the sensing signals 206 across the sensing area 204 to detect and measure characteristics of the sensing target 202 (e.g., and any other sensing targets in the sensing area 204). The sensing entity 110-a receives reflections of the sensing signals 206 from the sensing target 202 and measures characteristics of the reflected signals to determine information about the sensing target 202, such as a location, a velocity, a trajectory, and/or a type of the sensing target 202. The sensing entity 110-a performs the sensing operation according to one or more parameters received in a sensing request from a sensing function 108, as described with reference to FIG. 1. The parameters may include a sensing accuracy parameter that defines the precision or resolution of the sensing measurements, which may be expressed in terms of the size of scattering points within a sensing target blueprint.

The sensing entity 110-a may update the one or more parameters to satisfy privacy criteria configured for the sensing target 202 or the sensing area 204. For example, the sensing entity 110-a obtains privacy criteria from a local data storage or an external data storage, where the privacy criteria indicate a threshold value (e.g., a maximum sensing accuracy) for the sensing area 204. The sensing entity 110-a determines that a sensing accuracy value in the sensing request fails to satisfy the threshold value and modifies the sensing accuracy parameter from a first accuracy value (e.g., an accuracy value that enables identification of a type of the sensing target 202) to a second accuracy value that is lower than the first accuracy value (e.g., an accuracy value that disables identification of the type of the sensing target 202). The sensing entity 110-a performs the sensing operation using the modified parameters to obtain sensing measurements with the lower accuracy, thereby protecting the privacy of the sensing target 202, while enabling detection of the presence of the sensing target 202 within the sensing area 204.

FIG. 3 illustrates an example of a sensing diagram 300 in accordance with aspects of the present disclosure. In some examples, the sensing diagram 300 implements or is implemented by aspects of the wireless communications system 100 and the wireless communications system 200. For example, the sensing diagram 300 may be implemented by one or more NEs, which may be an example of NEs 102, sensing functions 108, and/or sensing entities 110, as described with reference to FIGS. 1 and 2. The sensing diagram 300 illustrates an example of a sensing target 302 and a corresponding sensing target blueprint 304 that represents the sensing target 302 as a pattern of scattering points.

The sensing target 302 represents a sensing target that a sensing entity may detect within a sensing area. The sensing target 302 may be an example of a human figure, including a head, torso, arms, and legs. The sensing target 302 may overlay a grid pattern rendered with high-resolution detail that enables identification of the type of the sensing target 302. The sensing target blueprint 304 represents a pixelized representation of the sensing target 302 as a pattern of scattering points. The sensing diagram 300 illustrates a transformation or mapping from the sensing target 302 to the sensing target blueprint 304, where the physical sensing target 302 is converted into a corresponding sensing target blueprint 304 used for detection and identification. The sensing target blueprint 304 displays a same form as the sensing target 302, but renders the form as a collection of discrete scattering points arranged in a grid pattern. Each scattering point in the sensing target blueprint 304 corresponds to a discrete location on or around the sensing target 302 from which transmitted sensing signals may reflect or scatter back toward the sensing entity.

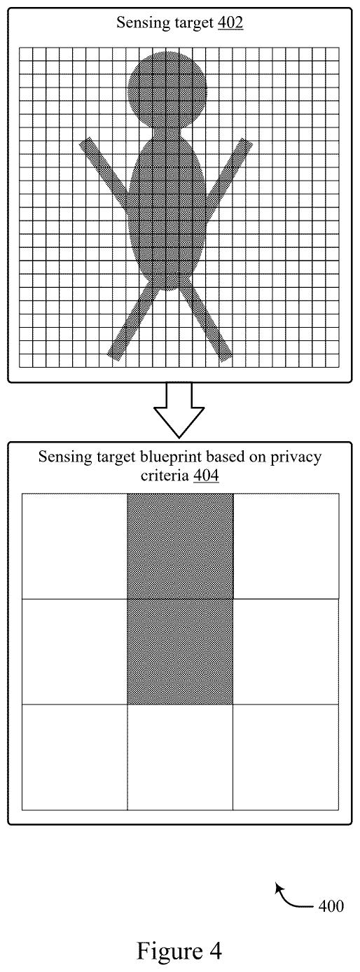

If the sensing accuracy is relatively high (e.g., exceeds or is greater than a threshold value, 5 centimeters by 5 centimeters per scattering point), the sensing target blueprint 304 includes sufficient detail to identify the type of the sensing target 302, such as distinguishing a human from an animal or a vehicle based on the characteristic arrangement of scattering points. A sensing function may compare the pattern of scattering points in the sensing target blueprint 304 to sensing measurements received from the sensing entity to determine whether a detected object corresponds to a type of sensing target. The sensing diagram 300 establishes a baseline sensing target blueprint 304 that the sensing function and/or the sensing entity may subsequently modify when privacy enforcement is enabled for a sensing area or sensing target, as described further with reference to FIG. 4.

FIG. 4 illustrates an example of a sensing diagram 400 in accordance with aspects of the present disclosure. In some examples, the sensing diagram 400 implements or is implemented by aspects of the wireless communications system 100, the wireless communications system 200, and the sensing diagram 300. For example, the sensing diagram 400 may be implemented by one or more NEs, which may be an example of NEs 102, sensing functions 108, and/or sensing entities 110, as described with reference to FIGS. 1 and 2. The sensing diagram 400 illustrates an example of a sensing target 402 and a corresponding sensing target blueprint based on privacy criteria 404 that represents the sensing target 402 as a pattern of scattering points.

The sensing target 402 represents a sensing target that a sensing entity may detect within a sensing area (e.g., the sensing target 302, as described with reference to FIG. 3). The sensing target 402 may be an example of a human figure rendered on a grid pattern with high-resolution detail. The sensing target blueprint based on privacy criteria 404 represents a modified pixelized representation of the sensing target 402 as a pattern of scattering points, where the NE (e.g., the sensing function and/or the sensing entity) adjusts the pattern to satisfy privacy criteria for the sensing area or the sensing target 402. The sensing diagram 400 illustrates a transformation or mapping from the sensing target 402 to the sensing target blueprint based on privacy criteria 404, where the NE converts the physical sensing target 402 into a corresponding sensing target blueprint based on privacy criteria 404 that has reduced resolution compared to the sensing target blueprint 304, as described with reference to FIG. 3.

The sensing target blueprint based on privacy criteria 404 displays a coarser representation of the sensing target 402, where the scattering points are larger and fewer in number compared to the sensing target blueprint 304. For example, the sensing target blueprint based on privacy criteria 404 may have a resolution of approximately 1 meter by 1 meter per scattering point, compared to a resolution of 5 centimeters by 5 centimeters per scattering point in the sensing target blueprint, as described with reference to FIG. 3. The reduced resolution in the sensing target blueprint based on privacy criteria 404 obscures the detailed characteristics of the sensing target 402, such that the sensing service consumer cannot identify the type of the sensing target 402 (e.g., whether the sensing target 402 is a human, an animal, or a vehicle) and/or other information about the sensing target 402 based on the pattern of scattering points. The sensing target blueprint based on privacy criteria 404 enables detection of the presence of the sensing target 402 within the sensing area, while reducing or preventing identification of the type of the sensing target 402, thereby satisfying privacy criteria configured for the sensing area or the sensing target 402.

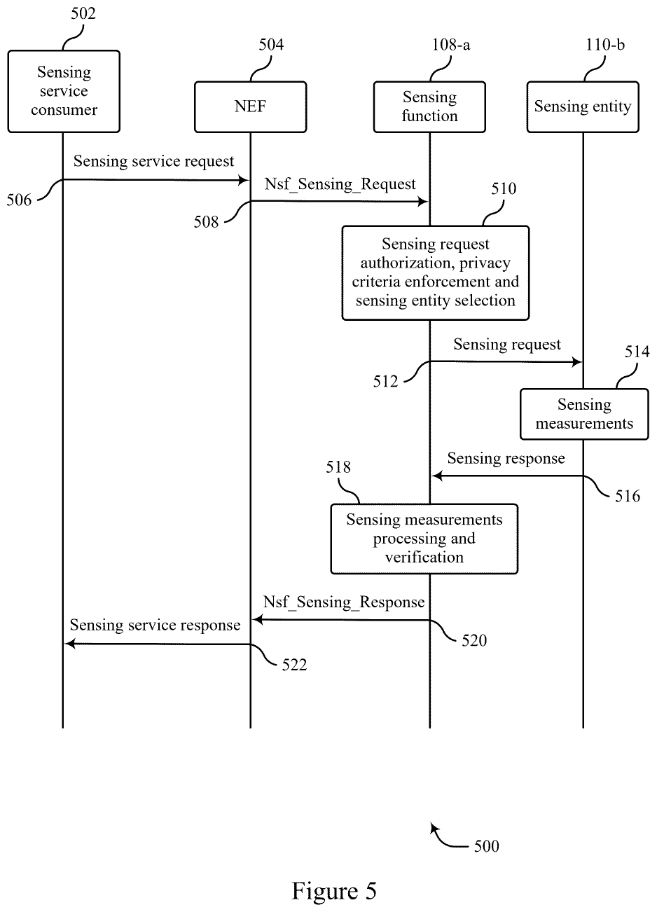

FIG. 5 illustrates an example of a signaling diagram 500 in accordance with aspects of the present disclosure. In some examples, the signaling diagram 500 implements or is implemented by aspects of the wireless communications system 100, the wireless communications system 200, the sensing diagram 300, and the sensing diagram 400. The signaling diagram 500 may implement or be implemented by one or more devices, such as a sensing function 108-a, the sensing entity 110-b, a sensing service consumer 502, and an NEF 504, which may be examples of a sensing function 108, a sensing entity 110, and corresponding NEs 102, as described with reference to FIGS. 1 and 2. The signaling diagram 500 may illustrate an example of privacy enforcement at a sensing function 108-a, where the sensing function 108-a receives a sensing request, performs privacy criteria enforcement by modifying sensing parameters, and coordinates with the sensing entity 110-b to obtain sensing measurements that satisfy the privacy criteria. Alternative examples of the following may be implemented, where some processes are performed in a different order than described or are not performed. In some cases, processes may include additional features not mentioned below, or further processes may be added.

At 506, the sensing service consumer 502 transmits a sensing service request to the NEF 504. The sensing service consumer 502 and the NEF 504 may have a security association. A security association may include established security credentials, authentication mechanisms, and/or encryption parameters that enable secure communication between the sensing service consumer 502 and the NEF 504. The sensing service request may include sensing service type information (e.g., object detection, object tracking, environment sensing), sensing service criteria (e.g., accuracy, latency, resolution), and time information indicating when the sensing service is to be performed (e.g., time for sensing measurement, time for sensing report). For example, the sensing service request may include one or more parameters (e.g., included in the sensing service criteria) associated with a sensing accuracy of the sensing operation. The parameters may include, but are not limited to, a sensing accuracy parameter indicating a resolution of scattering points (e.g., 5 centimeters by 5 centimeters per scattering point, 1 meter by 1 meter per scattering point), a latency parameter indicating a time criteria for obtaining sensing measurements, and/or a resolution parameter indicating a level of detail for the sensing measurements. Additionally, or alternatively, the sensing service request may include a sensing target blueprint indicating a pattern of scattering points that characterize a sensing target (e.g., human, cat, dog, car, tree) for accurate sensing target detection. The sensing service request may include a target sensing service area or a target device (e.g., UE or other device).

In some cases, the NEF 504 selects the sensing function 108-a for invoking the sensing service and to authorize the request. At 508, the NEF 504 transmits an Nsf_Sensing_Request to the sensing function 108-a. The Nsf_Sensing_Request may include an application function identifier and the sensing information (e.g., including the parameters and sensing target blueprint) received from the sensing service consumer 502. The sensing function 108-a obtains the request to trigger the sensing operation associated with the sensing target.

At 510, the sensing function 108-a authorizes the sensing service request from the sensing service consumer 502 and performs sensing entity selection utilizing information in the sensing request, such as the target sensing area. The sensing function 108-a performs privacy criteria enforcement. The sensing function 108-a obtains the privacy criteria from at least one of a local data storage at the sensing function 108-a or an external data storage accessible by the sensing function 108-a. For example, the sensing function 108-a may access a local data storage by querying a database or other memory at the sensing function 108-a that includes privacy configurations or privacy policy information indexed by geographic area identifiers or device identifiers. The sensing function 108-a may access an external data storage by transmitting a query message to a separate network function (e.g., NE) or server that maintains the privacy configuration or the privacy policy information, and receiving a response message including the applicable privacy criteria for the target sensing area or device.

The sensing function 108-a, the sensing entity 110-b, or another device or entity may configure the privacy criteria for at least one of a sensing area that includes the sensing target or a device within the sensing target. The request indicates the sensing area and/or the device. The privacy criteria indicate a threshold value associated with the sensing accuracy. The privacy criteria are based on one or more of a user consent granted by the sensing target, a geographic location of the sensing target, one or more legal policies governing the sensing target, one or more operator policies applicable to the sensing target, or a timing of the sensing operation. For example, the sensing function 108-a and/or the sensing entity 110-b may determine user consent based on a user registering with a mobile operator and indicating that a geographic area, such as a residence or property, has privacy protection enabled for sensing operations. The sensing function 108-a and/or the sensing entity 110-b may determine geographic location based on whether the sensing target is within a designated privacy zone, such as a private residence, a government building, or a company facility. The sensing function 108-a and/or the sensing entity 110-b may determine legal policies based on regulations that define sensing operations in jurisdictions or for types of sensing targets. The sensing function 108-a and/or the sensing entity 110-b may determine operator policies based on network operator configurations that define privacy criteria for geographic regions or user accounts. The sensing function 108-a and/or the sensing entity 110-b may determine timing based on time-of-day restrictions, such as enabling stricter privacy enforcement during nighttime hours or during event durations. The privacy criteria may define a geographic area defined by at least one of an antenna tilt range of the sensing entity 110-b or an angular range of the sensing entity 110-b.

The sensing function 108-a checks whether privacy is enabled in the target sensing area. If privacy is enabled, then the sensing function 108-a determines that the sensing target blueprint indicates a sensing accuracy value that fails to satisfy the threshold value prior to updating the one or more parameters. For example, the sensing function 108-a updates (e.g., modifies, adjusts, changes) the sensing accuracy parameter from a first accuracy value to a second accuracy value that is lower than the first accuracy value, where the update to the one or more parameters includes the second accuracy value. The first accuracy value may indicate a first resolution that enables identification of a type of the sensing target, and the second accuracy value may indicate a second resolution that disables identification of the type of the sensing target. The sensing function 108-a may modify the sensing target blueprint, where the sensing accuracy value satisfies the threshold value after modifying the sensing target blueprint. For example, the sensing function 108-a may modify the sensing target blueprint by reducing the number (e.g., amount, numerical quantity) of scattering points in the pattern, increasing the size of each scattering point (e.g., from 5 centimeters by 5 centimeters to 1 meter by 1 meter), removing scattering points that correspond to distinguishing features of the sensing target (e.g., scattering points corresponding to limbs, head shape, or other identifying characteristics), or aggregating multiple scattering points into fewer, larger scattering points. The modification to the sensing target blueprint results in a coarser representation that retains sufficient information to detect the presence of the sensing target within the sensing area, while obscuring the detailed shape or form that enables identification of the type of the sensing target, as described with reference to FIG. 4. The one or more parameters may include at least one of the pattern of the scattering points or the sensing accuracy value. Additionally, or alternatively, the sensing function 108-a may obtain an additional request from the NEF 504 to trigger an additional sensing operation for an additional sensing target. The sensing function 108-a may output an indication to the NEF 504 that the additional request is rejected due to additional privacy criteria configured for the additional sensing target (e.g., in case of strict privacy configuration, where no presence information about any object is to be revealed).

At 512, the sensing function 108-a outputs the request to the sensing entity 110-b with the update to the one or more parameters to satisfy the privacy criteria for the sensing target. For example, the sensing request includes the modified sensing information with the update to the one or more parameters.

At 514, the sensing entity 110-b performs sensing measurements according to the modified sensing information in the sensing request from the sensing function 108-a. For example, the sensing entity 110-b performs the sensing operation based on the update to the one or more parameters.

At 516, the sensing entity 110-b transmits a sensing response to the sensing function 108-a. The sensing response includes the one or more sensing measurements (e.g., with low accuracy resulting from the update to the one or more parameters). For example, the sensing function 108-a obtains the one or more sensing measurements associated with the sensing target based on the update to the one or more parameters.

At 518, the sensing function 108-a performs sensing measurements processing and verification. The sensing function 108-a determines that the one or more sensing measurements satisfy the privacy criteria based on the update to the one or more parameters. For example, the sensing function 108-a verifies whether the sensing measurements were performed according to the privacy enforcement modification in the sensing information. The sensing function 108-a may verify the sensing measurements by comparing a resolution or accuracy of the received sensing measurements to the modified parameters that were transmitted to the sensing entity 110-b. For example, the sensing function 108-a may analyze the granularity of the scattering point data in the sensing measurements to confirm that the measurements correspond to the reduced accuracy level (e.g., 1 meter by 1 meter per scattering point), rather than the originally requested higher accuracy level (e.g., 5 centimeters by 5 centimeters per scattering point). The sensing function 108-a may also verify that the sensing measurements do not include sufficient detail to enable identification of the type of the sensing target. In some cases, the sensing function 108-a may apply pattern matching or comparison algorithms to determine whether the sensing measurements could be used to distinguish between different types of sensing targets (e.g., human, animal, vehicle). If the sensing measurements satisfy the privacy criteria, then the sensing function 108-a proceeds to output the sensing measurements. If the sensing measurements fail to satisfy the privacy criteria (e.g., if the sensing entity 110-b did not properly apply the modified parameters), then the sensing function 108-a may discard the sensing measurements, request new sensing measurements from the sensing entity 110-b with the correct parameters, and/or further reduce the resolution of the sensing measurements before forwarding the results.

At 520, the sensing function 108-a outputs the one or more sensing measurements and an indication that the privacy criteria are satisfied to the NEF 504, based on the one or more sensing measurements satisfying the privacy criteria.

At 522, the NEF 504 forwards the sensing service response to the sensing service consumer 502. The sensing service response includes the sensing information result from the sensing procedure and the indication that privacy enforcement is enabled.

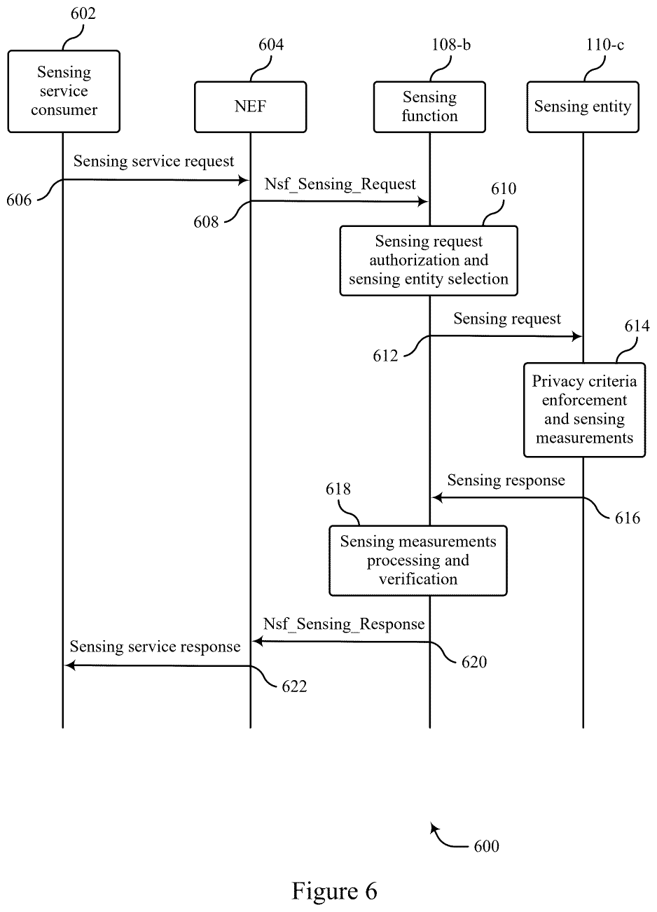

FIG. 6 illustrates an example of a signaling diagram 600 in accordance with aspects of the present disclosure. In some examples, the signaling diagram 600 implements or is implemented by aspects of the wireless communications system 100, the wireless communications system 200, the sensing diagram 300, the sensing diagram 400, and the signaling diagram 500. The signaling diagram 600 may implement or be implemented by one or more devices, such as a sensing function 108-b, the sensing entity 110-c, a sensing service consumer 602, and an NEF 604, which may be examples of a sensing function 108, a sensing entity 110, and corresponding NEs 102, as described with reference to FIGS. 1, 2, and 5. The signaling diagram 600 may illustrate an example of privacy enforcement at a sensing entity 110-c, where the sensing entity 110-c receives a sensing request and performs sensing measurements that satisfy the privacy criteria. Alternative examples of the following may be implemented, where some processes are performed in a different order than described or are not performed. In some cases, processes may include additional features not mentioned below, or further processes may be added.

At 606, the sensing service consumer 602 transmits a sensing service request to the NEF 604. The sensing service consumer 602 and the NEF 604 may have a security association. A security association may include established security credentials, authentication mechanisms, and/or encryption parameters that enable secure communication between the sensing service consumer 602 and the NEF 604. The sensing service request may include sensing service type information (e.g., object detection, object tracking, environment sensing), sensing service criteria (e.g., accuracy, latency, resolution), and time information indicating when the sensing service is to be performed (e.g., time for sensing measurement, time for sensing report). For example, the sensing service request may include one or more parameters (e.g., included in the sensing service criteria) associated with a sensing accuracy of the sensing operation. The parameters may include, but are not limited to, a sensing accuracy parameter indicating a resolution of scattering points (e.g., 5 centimeters by 5 centimeters per scattering point, 1 meter by 1 meter per scattering point), a latency parameter indicating a time criteria for obtaining sensing measurements, and/or a resolution parameter indicating a level of detail for the sensing measurements. Additionally, or alternatively, the sensing service request may include a sensing target blueprint indicating a pattern of scattering points that characterize a sensing target (e.g., human, cat, dog, car, tree) for accurate sensing target detection. The sensing service request may include a target sensing service area or a target device (e.g., UE or other device).

In some cases, the NEF 604 selects the sensing function 108-b for invoking the sensing service and to authorize the request. At 608, the NEF 604 transmits an Nsf_Sensing_Request to the sensing function 108-b. The Nsf_Sensing_Request may include an application function identifier and the sensing information (e.g., including the parameters and sensing target blueprint) received from the sensing service consumer 602. The sensing function 108-b obtains the request to trigger the sensing operation associated with the sensing target.

At 610, the sensing function 108-b authorizes the sensing service request from the sensing service consumer 602 and performs sensing entity selection utilizing information in the sensing request, such as the target sensing area. The sensing function 108-b selects the sensing entity 110-c to perform the sensing operation.

At 612, the sensing function 108-b outputs the request to the sensing entity 110-c. For example, the sensing request includes the sensing information with the one or more parameters associated with the sensing accuracy of the sensing operation. The sensing entity 110-c obtains the request to trigger the sensing operation associated with the sensing target.

At 614, the sensing entity 110-c performs privacy criteria enforcement and sensing measurements. The sensing entity 110-c obtains the privacy criteria from at least one of a local data storage at the sensing entity 110-c or an external data storage accessible by the sensing entity 110-c. For example, the sensing entity 110-c may access a local data storage by querying a database or other memory at the sensing entity 110-c that includes privacy configurations or privacy policy information indexed by geographic area identifiers or device identifiers. The sensing entity 110-c may access an external data storage by transmitting a query message to a separate network function (e.g., NE) or server that maintains the privacy configuration or the privacy policy information, and receiving a response message including the applicable privacy criteria for the target sensing area.

The sensing entity 110-c or another device or entity may configure the privacy criteria for a sensing area associated with the sensing target. The privacy criteria indicate a threshold value associated with the sensing accuracy. The privacy criteria are based on one or more of a user consent granted by the sensing target, a geographic location of the sensing target, one or more legal policies governing the sensing target, one or more operator policies applicable to the sensing target, or a timing of the sensing operation. For example, the sensing entity 110-c may determine user consent based on a user registering with a mobile operator and indicating that a geographic area, such as a residence or property, has privacy protection enabled for sensing operations. The sensing entity 110-c may determine geographic location based on whether the sensing target is within a designated privacy zone, such as a private residence, a government building, or a company facility. The sensing entity 110-c may determine legal policies based on regulations that define sensing operations in jurisdictions or for types of sensing targets. The sensing entity 110-c may determine operator policies based on network operator configurations that define privacy criteria for geographic regions or user accounts. The sensing entity 110-c may determine timing based on time-of-day restrictions, such as enabling strict privacy enforcement during nighttime hours or during event durations. The privacy criteria may define a geographic area defined by at least one of an antenna tilt range of the sensing entity 110-c or an angular range of the sensing entity 110-c.

The sensing entity 110-c checks whether privacy is enabled in the target sensing area. If privacy is enabled, then the sensing entity 110-c determines that the sensing target blueprint indicates a sensing accuracy value that fails to satisfy the threshold value prior to updating the one or more parameters. For example, the sensing entity 110-c updates (e.g., modifies, adjusts, changes) the sensing accuracy parameter from a first accuracy value to a second accuracy value that is lower than the first accuracy value, where the update to the one or more parameters includes the second accuracy value. The first accuracy value may indicate a first resolution that enables identification of a type of the sensing target, and the second accuracy value may indicate a second resolution that disables identification of the type of the sensing target. The sensing entity 110-c may modify the sensing target blueprint, where the sensing accuracy value satisfies the threshold value after modifying the sensing target blueprint. For example, the sensing entity 110-c may modify the sensing target blueprint by reducing the number (e.g., amount, numerical quantity) of scattering points in the pattern, increasing the size of each scattering point (e.g., from 5 centimeters by 5 centimeters to 1 meter by 1 meter), removing scattering points that correspond to distinguishing features of the sensing target (e.g., scattering points corresponding to limbs, head shape, or other identifying characteristics), or aggregating multiple scattering points into fewer, larger scattering points. The modification to the sensing target blueprint results in a coarser representation that retains sufficient information to detect the presence of the sensing target within the sensing area, while obscuring the detailed shape or form that enables identification of the type of the sensing target. Additionally, or alternatively, the sensing entity 110-c may obtain an additional request to trigger an additional sensing operation for an additional sensing target. The sensing entity 110-c may output an indication that the additional request is rejected due to additional privacy criteria associated with the additional sensing target (e.g., in case of strict privacy configuration, where no presence information about any object is to be revealed).

The sensing entity 110-c performs the sensing operation based on the update to the one or more parameters. For example, the sensing entity 110-c performs the sensing operation to obtain one or more sensing measurements, where the update to the one or more parameters satisfies the privacy criteria associated with the sensing target.

At 616, the sensing entity 110-c transmits a sensing response to the sensing function 108-b. The sensing response includes the one or more sensing measurements (e.g., with low accuracy resulting from the update to the one or more parameters) and an indication that the privacy criteria are satisfied. For example, the sensing entity 110-c outputs the one or more sensing measurements and the indication that the privacy criteria are satisfied based on the request.

At 618, the sensing function 108-b performs sensing measurements processing and verification. The sensing function 108-b verifies the sensing measurements considering the privacy enforcement modification in the sensing information. For example, the sensing function 108-b may verify the sensing measurements by comparing a resolution or accuracy of the received sensing measurements to determine that the measurements correspond to the reduced accuracy level (e.g., 1 meter by 1 meter per scattering point), rather than the originally requested higher accuracy level (e.g., 5 centimeters by 5 centimeters per scattering point). The sensing function 108-b may also verify that the sensing measurements do not include sufficient detail to enable identification of the type of the sensing target.

At 620, the sensing function 108-b outputs the one or more sensing measurements and an indication that the privacy criteria are satisfied to the NEF 604, based on the one or more sensing measurements satisfying the privacy criteria.

At 622, the NEF 604 forwards the sensing service response to the sensing service consumer 602. The sensing service response includes the sensing information result from the sensing procedure and the indication that privacy enforcement is enabled.

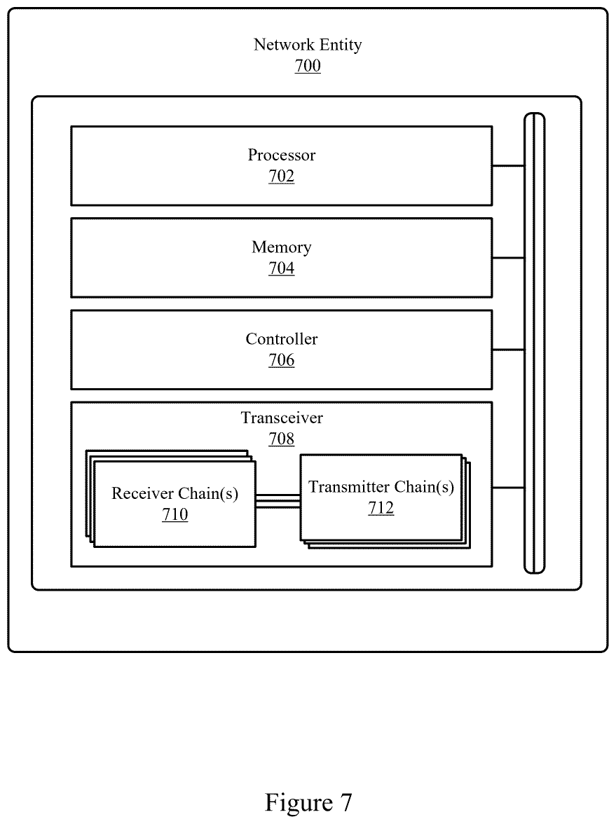

FIG. 7 illustrates an example of an NE 700 (e.g., a sensing function and/or a sensing entity) in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof, may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof, may be implemented in hardware (e.g., circuitry). The hardware may include a processor, a digital signal processor (DSP), an application-specific integrated circuit (ASIC), or other programmable logic device, or any combination thereof, configured as or otherwise supporting a means for performing the functions described in the present disclosure.

The processor 702 may include an intelligent hardware device (e.g., a general-purpose processor, a DSP, a central processing unit (CPU), an ASIC, a field-programmable gate-array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code, including instructions that, when executed by the processor 702, cause the NE 700 to perform various functions described herein. The code may be stored in a non-transitory computer-readable medium, such as the memory 704 or another type of memory. Computer-readable media include both non-transitory computer storage media and communication media, including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 (e.g., a sensing function) may be configured to or operable to support a means for obtaining a request to trigger a sensing operation associated with a sensing target, where the request includes one or more parameters associated with a sensing accuracy of the sensing operation, outputting, to a second NE (e.g., a sensing entity), the request with an update to the one or more parameters to satisfy a privacy criteria associated with the sensing target, where the privacy criteria indicates a threshold value associated with the sensing accuracy, and obtaining, based on the update to the one or more parameters, one or more sensing measurements associated with the sensing target. By updating the sensing parameters to satisfy privacy criteria, the NE 700 may provide improved data privacy and reduced unauthorized data exposure during sensing operations, while enabling detection of sensing targets within the sensing area.

Additionally, the NE 700 may be configured to or operable to support any one or combination of obtaining, from at least one of a local data storage associated with the NE 700 or an external data storage accessible by the NE 700, the privacy criteria, where the privacy criteria are associated with at least one of a sensing area associated with the sensing target or a device associated with the sensing target, and where the request indicates the at least one of the sensing area or the device. By obtaining privacy criteria from local or external data storage, the NE 700 may enable flexible and configurable privacy enforcement based on sensing areas or devices. Additionally, or alternatively, the NE 700 may be configured to or operable to support the one or more parameters including a sensing accuracy parameter, and modifying the sensing accuracy parameter from a first accuracy value to a second accuracy value that is lower than the first accuracy value, where the update to the one or more parameters includes the second accuracy value. By modifying the sensing accuracy parameter to a lower value, the NE 700 may reduce the granularity of sensing data collected for privacy-restricted sensing targets or sensing areas. Additionally, or alternatively, the NE 700 may be configured or operable to support the first accuracy value corresponding to a first resolution that enables identification of a type of the sensing target, and the second accuracy value corresponding to a second resolution that disables identification of the type of the sensing target. By transitioning from a resolution that enables identification to one that disables identification, the NE 700 may reduce or prevent privacy violations by obscuring the ability to distinguish object types.

Additionally, or alternatively, the NE 700 may be configured or operable to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint, and where the one or more parameters include at least one of the pattern of the scattering points or the sensing accuracy value. By modifying the sensing target blueprint to satisfy the threshold value, the NE 700 may ensure that sensing operations comply with privacy criteria, while enabling presence detection. Additionally, or alternatively, the NE 700 may be configured or operable to support determining, based on the update to the one or more parameters, that the one or more sensing measurements satisfy the privacy criteria, and outputting, to a third NE and based on the one or more sensing measurements satisfying the privacy criteria, the one or more sensing measurements and an indication that the privacy criteria are satisfied, where the third NE includes an NEF. By outputting an indication that privacy criteria are satisfied, the NE 700 may provide transparency to sensing service consumers regarding the privacy enforcement status of the sensing measurements. Additionally, or alternatively, the NE 700 may be configured or operable to support obtaining, from a third NE (e.g., an NEF), an additional request to trigger an additional sensing operation associated with an additional sensing target, where the third NE includes an NEF, and outputting, to the third NE, an indication that the additional request is rejected based on additional privacy criteria associated with the additional sensing target. By rejecting requests that cannot satisfy privacy criteria, the NE 700 may prevent unauthorized collection of privacy-sensitive sensing data in strictly protected areas. Additionally, or alternatively, the NE 700 may be configured to support the privacy criteria being associated with a geographic area defined by at least one of an antenna tilt range associated with the second NE or an angular range associated with the second NE. By defining privacy criteria based on antenna tilt range or angular range, the NE 700 may enable geographic delineation of privacy-protected sensing areas. Additionally, or alternatively, the NE 700 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation. By basing privacy criteria on multiple factors including user consent, location, and policies, the NE 700 may provide comprehensive and adaptable privacy protection that complies with various regulatory and operational criteria. Additionally, or alternatively, the NE 700 may be configured to support the NE 700 including a sensing function, and the second NE including a sensing entity. By distributing privacy enforcement between the sensing function and sensing entity, the NE 700 may enable flexible deployment architectures for privacy-compliant sensing operations.

Additionally, or alternatively, the NE 700 may support at least one memory (e.g., the memory 704) and at least one processor (e.g., the processor 702) coupled with the at least one memory and configured to cause the NE 700 (e.g., the sensing function) to obtain a request to trigger a sensing operation associated with a sensing target, where the request includes one or more parameters associated with a sensing accuracy of the sensing operation, output, to a second NE, the request with an update to the one or more parameters to satisfy a privacy criteria associated with the sensing target, where the privacy criteria indicates a threshold value associated with the sensing accuracy, and obtain, based on the update to the one or more parameters, one or more sensing measurements associated with the sensing target.

Additionally, the NE 700 may be configured to support any one or combination of obtaining, from at least one of a local data storage associated with the NE 700 or an external data storage accessible by the NE 700, the privacy criteria, where the privacy criteria are associated with at least one of a sensing area associated with the sensing target or a device associated with the sensing target, and where the request indicates the at least one of the sensing area or the device. Additionally, or alternatively, the NE 700 may be configured to support the one or more parameters including a sensing accuracy parameter, and modifying the sensing accuracy parameter from a first accuracy value to a second accuracy value that is lower than the first accuracy value, where the update to the one or more parameters includes the second accuracy value. Additionally, or alternatively, the NE 700 may be configured to support the first accuracy value corresponding to a first resolution that enables identification of a type of the sensing target, and the second accuracy value corresponding to a second resolution that disables identification of the type of the sensing target.

Additionally, or alternatively, the NE 700 may be configured to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint, and where the one or more parameters include at least one of the pattern of the scattering points or the sensing accuracy value. Additionally, or alternatively, the NE 700 may be configured to support determining, based on the update to the one or more parameters, that the one or more sensing measurements satisfy the privacy criteria, and outputting, to a third NE and based on the one or more sensing measurements satisfying the privacy criteria, the one or more sensing measurements and an indication that the privacy criteria are satisfied, where the third NE includes an NEF. Additionally, or alternatively, the NE 700 may be configured to support obtaining, from a third NE, an additional request to trigger an additional sensing operation associated with an additional sensing target, where the third NE includes an NEF, and outputting, to the third NE, an indication that the additional request is rejected based on additional privacy criteria associated with the additional sensing target. Additionally, or alternatively, the NE 700 may be configured to support the privacy criteria being associated with a geographic area defined by at least one of an antenna tilt range associated with the second NE or an angular range associated with the second NE. Additionally, or alternatively, the NE 700 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation. Additionally, or alternatively, the NE 700 may be configured to support the NE 700 including a sensing function, and the second NE including a sensing entity.

Additionally, or alternatively, the NE 700 (e.g., a sensing entity) may be configured to or operable to support a means for obtaining a request to trigger a sensing operation associated with a sensing target, where the request includes one or more parameters associated with a sensing accuracy of the sensing operation, performing, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy, and outputting, based on the request, the one or more sensing measurements and an indication that the privacy criteria are satisfied. By performing the sensing operation with updated parameters and outputting a privacy satisfaction indication, the NE 700 may enable privacy-compliant sensing, while providing transparency regarding the privacy enforcement status to requesting entities.

Additionally, the NE 700 may be configured to or operable to support any one or combination of obtaining, from at least one of a local data storage associated with the NE 700 or an external data storage accessible by the NE 700, the privacy criteria, where the privacy criteria are associated with a sensing area associated with the sensing target. By obtaining privacy criteria associated with sensing areas, the NE 700 may enable location-based privacy enforcement for geographic regions such as private residences or government buildings. Additionally, or alternatively, the NE 700 may be configured to support the one or more parameters including a sensing accuracy parameter, and modifying the sensing accuracy parameter from a first accuracy value to a second accuracy value that is lower than the first accuracy value, where the update to the one or more parameters includes the second accuracy value. By modifying the sensing accuracy parameter to a lower value, the NE 700 may reduce the detail level of sensing measurements to protect privacy-sensitive information. Additionally, or alternatively, the NE 700 may be configured to support the first accuracy value corresponding to a first resolution that enables identification of a type of the sensing target, and the second accuracy value corresponding to a second resolution that disables identification of the type of the sensing target. By supporting resolution transitions that disable identification, the NE 700 may prevent unauthorized determination of sensing target types, while maintaining presence detection capabilities.

Additionally, or alternatively, the NE 700 may be configured to or be operable to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint. By modifying the sensing target blueprint to satisfy threshold values, the NE 700 may ensure that scattering point patterns do not reveal privacy-sensitive characteristics of sensing targets. Additionally, or alternatively, the NE 700 may be configured to support obtaining an additional request to trigger an additional sensing operation associated with an additional sensing target, and outputting an additional indication that the additional request is rejected based on additional privacy criteria associated with the additional sensing target. By rejecting requests based on privacy criteria, the NE 700 may prevent sensing operations in areas where no sensing data collection is permitted. Additionally, or alternatively, the NE 700 may be configured to support the privacy criteria being associated with a geographic area defined by at least one of an antenna tilt range associated with the NE 700 or an angular range associated with the NE 700. By defining privacy areas using antenna tilt and angular ranges, the NE 700 may enable precise spatial delineation of privacy-protected regions within the sensing coverage area. Additionally, or alternatively, the NE 700 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation, and the NE 700 including a sensing entity. By supporting comprehensive privacy criteria factors at the sensing entity level, the NE 700 may enable localized privacy enforcement that accounts for consent, location, policies, and timing considerations.

Additionally, or alternatively, the NE 700 may support at least one memory (e.g., the memory 704) and at least one processor (e.g., the processor 702) coupled with the at least one memory and configured to cause the NE 700 (e.g., a sensing entity) to obtain a request to trigger a sensing operation associated with a sensing target, where the request includes one or more parameters associated with a sensing accuracy of the sensing operation, perform, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy, and output, based on the request, the one or more sensing measurements and an indication that the privacy criteria are satisfied.

Additionally, the NE 700 may be configured to support any one or combination of obtaining, from at least one of a local data storage associated with the NE 700 or an external data storage accessible by the NE 700, the privacy criteria, where the privacy criteria are associated with a sensing area associated with the sensing target. Additionally, or alternatively, the NE 700 may be configured to support the one or more parameters including a sensing accuracy parameter, and modifying the sensing accuracy parameter from a first accuracy value to a second accuracy value that is lower than the first accuracy value, where the update to the one or more parameters includes the second accuracy value. Additionally, or alternatively, the NE 700 may be configured to support the first accuracy value corresponding to a first resolution that enables identification of a type of the sensing target, and the second accuracy value corresponding to a second resolution that disables identification of the type of the sensing target.

Additionally, or alternatively, the NE 700 may be configured to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint. Additionally, or alternatively, the NE 700 may be configured to support obtaining an additional request to trigger an additional sensing operation associated with an additional sensing target, and outputting an additional indication that the additional request is rejected based on additional privacy criteria associated with the additional sensing target. Additionally, or alternatively, the NE 700 may be configured to support the privacy criteria being associated with a geographic area defined by at least one of an antenna tilt range associated with the NE 700 or an angular range associated with the NE 700. Additionally, or alternatively, the NE 700 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation, and the NE 700 including a sensing entity.

The controller 706 may manage input and output signals for the NE 700. The controller 706 may also manage peripherals not integrated into the NE 700. In some implementations, the controller 706 may utilize an operating system such as iOS®, Android®, Windows®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

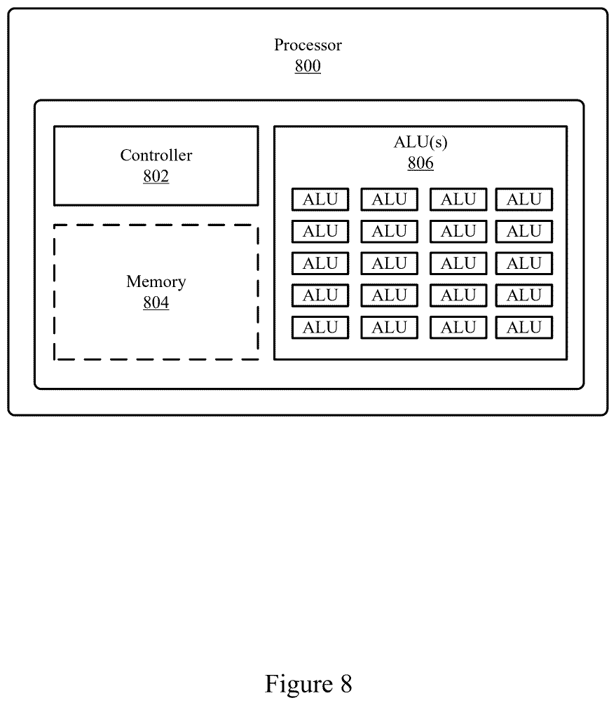

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory addresses of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage the flow of data within the processor 800. The controller 802 may be configured to control the transfer of data between registers, ALUs 806, and other functional units of the processor 800.

The memory 804 may include one or more caches (e.g., memory local to or included in the processor 800 or other memory, such as RAM, ROM, DRAM, SDRAM, SRAM, MRAM, flash memory, etc.). In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, and the controller 802, and may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations, such as addition, subtraction, multiplication, and division, on data. For example, one or more ALUs 806 may receive input operands and an operation code, which determines an operation to be executed. One or more ALUs 806 may be configured with a variety of logical and arithmetic circuits, including adders, subtractors, shifters, and logic gates, to process and manipulate the data according to the operation. Additionally, or alternatively, the one or more ALUs 806 may support logical operations, such as AND, OR, exclusive-OR (XOR), not-OR (NOR), and not-AND (NAND), enabling the one or more ALUs 806 to handle conditional operations, comparisons, and bitwise operations.

The processor 800 may be configured to, or operable to, support at least one controller (e.g., the controller 802) coupled with at least one memory (e.g., the memory 804) and configured to cause the processor 800 (e.g., a processor of a sensing function) to obtain a request to trigger a sensing operation associated with a sensing target, where the request includes one or more parameters associated with a sensing accuracy of the sensing operation, output, to a second NE, the request with an update to the one or more parameters to satisfy a privacy criteria associated with the sensing target, where the privacy criteria indicates a threshold value associated with the sensing accuracy, and obtain, based on the update to the one or more parameters, one or more sensing measurements associated with the sensing target. By utilizing the controller and memory to process sensing requests and update parameters to satisfy privacy criteria, the processor 800 may enable privacy-compliant sensing operations, while maintaining the ability to obtain sensing measurements for legitimate purposes.

Additionally, the processor 800 may be configured to support any one or combination of obtaining, from at least one of a local data storage associated with the processor 800 or an external data storage accessible by the processor 800, the privacy criteria, where the privacy criteria are associated with at least one of a sensing area associated with the sensing target or a device associated with the sensing target, and where the request indicates the at least one of the sensing area or the device. By obtaining privacy criteria from local or external data storage, the processor 800 may enable flexible and configurable privacy enforcement based on sensing areas or devices. Additionally, or alternatively, the processor 800 may be configured to support the one or more parameters including a sensing accuracy parameter, and modifying the sensing accuracy parameter from a first accuracy value to a second accuracy value that is lower than the first accuracy value, where the update to the one or more parameters includes the second accuracy value. By modifying the sensing accuracy parameter to a lower value, the processor 800 may reduce the detail level of sensing measurements to protect privacy-sensitive information, while enabling sensing functionality. Additionally, or alternatively, the processor 800 may be configured to support the first accuracy value corresponding to a first resolution that enables identification of a type of the sensing target, and the second accuracy value corresponding to a second resolution that disables identification of the type of the sensing target. By supporting resolution transitions that disable identification, the processor 800 may prevent unauthorized determination of sensing target types, while maintaining presence detection capabilities. Additionally, or alternatively, the processor 800 may be configured to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint, and where the one or more parameters include at least one of the pattern of the scattering points or the sensing accuracy value. By modifying the sensing target blueprint to satisfy threshold values, the processor 800 may ensure that scattering point patterns do not reveal privacy-sensitive characteristics of sensing targets.

Additionally, or alternatively, the processor 800 may be configured to support determining, based on the update to the one or more parameters, that the one or more sensing measurements satisfy the privacy criteria, and outputting, to a third NE and based on the one or more sensing measurements satisfying the privacy criteria, the one or more sensing measurements and an indication that the privacy criteria are satisfied, where the third NE includes an NEF. By outputting sensing measurements with a privacy satisfaction indication to the NEF, the processor 800 may enable downstream entities to verify that privacy criteria have been met. Additionally, or alternatively, the processor 800 may be configured to support obtaining, from a third NE, an additional request to trigger an additional sensing operation associated with an additional sensing target, where the third NE includes an NEF, and outputting, to the third NE, an indication that the additional request is rejected based on additional privacy criteria associated with the additional sensing target. By rejecting requests based on privacy criteria, the processor 800 may prevent sensing operations in areas where no sensing data collection is permitted. Additionally, or alternatively, the processor 800 may be configured to support the privacy criteria being associated with a geographic area defined by at least one of an antenna tilt range associated with the second NE or an angular range associated with the second NE. By defining privacy areas using antenna tilt and angular ranges, the processor 800 may enable precise spatial delineation of privacy-protected regions within the sensing coverage area. Additionally, or alternatively, the processor 800 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation. By supporting comprehensive privacy criteria factors, the processor 800 may enable privacy enforcement that accounts for consent, location, policies, and timing considerations. Additionally, or alternatively, the processor 800 may be configured to support the processor 800 being associated with a sensing function, and the second NE including a sensing entity. By associating the processor 800 with a sensing function that communicates with a sensing entity, the processor 800 may enable centralized privacy enforcement at the network function level.

The processor 800 may be configured to or operable to support at least one controller (e.g., the controller 802) coupled with at least one memory (e.g., the memory 804) and configured to cause the processor 800 (e.g., a processor of a sensing entity) to obtain a request to trigger a sensing operation associated with a sensing target, where the request includes one or more parameters associated with a sensing accuracy of the sensing operation, perform, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy, and output, based on the request, the one or more sensing measurements and an indication that the privacy criteria are satisfied. By utilizing the controller and memory to perform privacy-compliant sensing operations and output measurements with privacy satisfaction indications, the processor 800 may provide integrated privacy enforcement at the sensing entity level, while maintaining sensing functionality.

Additionally, the processor 800 may be configured to support any one or combination of obtaining, from at least one of a local data storage associated with the processor 800 or an external data storage accessible by the processor 800, the privacy criteria, where the privacy criteria are associated with a sensing area associated with the sensing target. By accessing privacy criteria from data storage, the processor 800 may enable configurable and updatable privacy enforcement for different sensing areas. Additionally, or alternatively, the processor 800 may be configured to support the one or more parameters including a sensing accuracy parameter, and modifying the sensing accuracy parameter from a first accuracy value to a second accuracy value that is lower than the first accuracy value, where the update to the one or more parameters includes the second accuracy value. By reducing the sensing accuracy parameter, the processor 800 may collect sensing measurements with reduced granularity that protects privacy-sensitive information. Additionally, or alternatively, the processor 800 may be configured to support the first accuracy value corresponding to a first resolution that enables identification of a type of the sensing target, and the second accuracy value corresponding to a second resolution that disables identification of the type of the sensing target. By transitioning to a resolution that disables identification, the processor 800 may ensure that sensing measurements cannot be used to distinguish object types.

Additionally, or alternatively, the processor 800 may be configured to support the request including a sensing target blueprint indicating a pattern of scattering points associated with the sensing target, and determining that the sensing target blueprint is associated with a sensing accuracy value that fails to satisfy the threshold value prior to updating the one or more parameters, and modifying the sensing target blueprint, where the sensing accuracy value satisfies the threshold value based on modifying the sensing target blueprint. By modifying the sensing target blueprint, the processor 800 may reduce the scattering point resolution to reduce or prevent detailed object characterization, while maintaining basic detection capabilities. Additionally, or alternatively, the processor 800 may be configured to support obtaining an additional request to trigger an additional sensing operation associated with an additional sensing target, and outputting an additional indication that the additional request is rejected based on additional privacy criteria associated with the additional sensing target. By rejecting non-compliant sensing requests, the processor 800 may enforce strict privacy protection in areas where sensing operations are prohibited. Additionally, or alternatively, the processor 800 may be configured to support the privacy criteria being associated with a geographic area defined by at least one of an antenna tilt range associated with the processor 800 or an angular range associated with the processor 800. By utilizing antenna configuration parameters to define privacy areas, the processor 800 may enable accurate and practical geographic privacy enforcement. Additionally, or alternatively, the processor 800 may be configured to support the privacy criteria being based on one or more of a user consent associated with the sensing target, a geographic location associated with the sensing target, one or more legal policies associated with the sensing target, one or more operator policies associated with the sensing target, or a timing associated with the sensing operation, and the processor 800 being associated with a sensing entity. By supporting multiple privacy criteria factors as a sensing entity, the processor 800 may provide comprehensive privacy enforcement that adapts to user preferences, regulatory criteria, and operational policies.

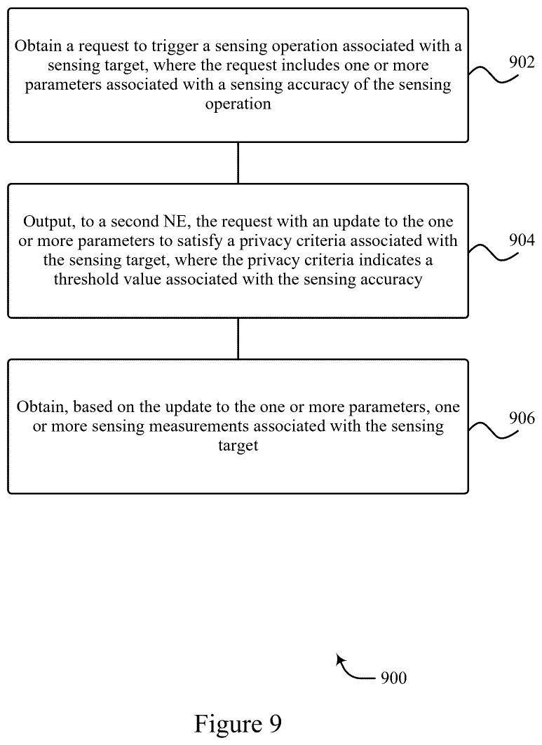

FIG. 9 illustrates a flowchart of a method 900 performed by an NE (e.g., a sensing function) in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified, and that other implementations are possible.

At 902, the method may include obtaining a request to trigger a sensing operation associated with a sensing target, where the request includes one or more parameters associated with a sensing accuracy of the sensing operation. The operations of 902 may be performed in accordance with examples as described herein. In some implementations, aspects of the operations of 902 may be performed by an NE (e.g., a sensing function) as described with reference to FIG. 7.

At 904, the method may include outputting, to a second NE, the request with an update to the one or more parameters to satisfy a privacy criteria associated with the sensing target, where the privacy criteria indicates a threshold value associated with the sensing accuracy. The operations of 904 may be performed in accordance with examples as described herein. In some implementations, aspects of the operations of 904 may be performed by an NE (e.g., a sensing function), as described with reference to FIG. 7.

At 906, the method may include obtaining, based on the update to the one or more parameters, one or more sensing measurements associated with the sensing target. The operations of 906 may be performed in accordance with examples as described herein. In some implementations, aspects of the operations of 906 may be performed by an NE (e.g., a sensing function), as described with reference to FIG. 7.

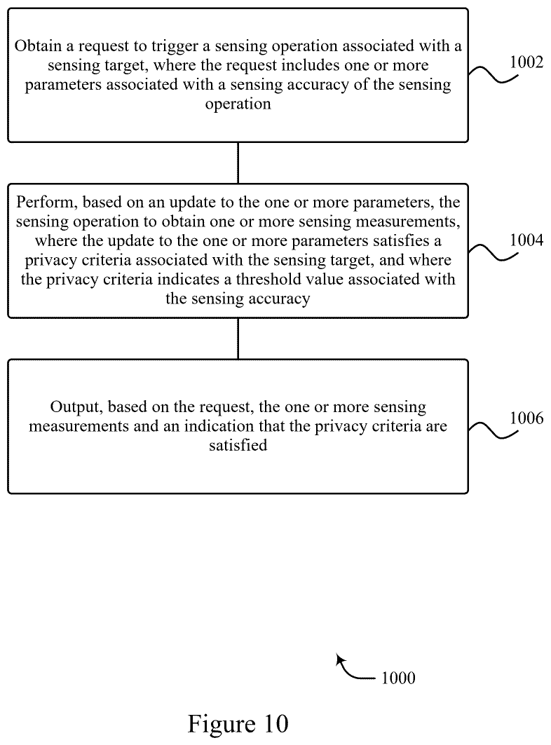

FIG. 10 illustrates a flowchart of a method 1000 performed by an NE (e.g., a sensing entity) in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include obtaining a request to trigger a sensing operation associated with a sensing target, where the request includes one or more parameters associated with a sensing accuracy of the sensing operation. The operations of 1002 may be performed in accordance with examples as described herein. In some implementations, aspects of the operations of 1002 may be performed by an NE (e.g., a sensing entity), as described with reference to FIG. 7.

At 1004, the method may include performing, based on an update to the one or more parameters, the sensing operation to obtain one or more sensing measurements, where the update to the one or more parameters satisfies a privacy criteria associated with the sensing target, and where the privacy criteria indicates a threshold value associated with the sensing accuracy. The operations of 1004 may be performed in accordance with examples as described herein. In some implementations, aspects of the operations of 1004 may be performed by an NE (e.g., a sensing entity), as described with reference to FIG. 7.

At 1006, the method may include outputting, based on the request, the one or more sensing measurements and an indication that the privacy criteria are satisfied. The operations of 1006 may be performed in accordance with examples as described herein. In some implementations, aspects of the operations of 1006 may be performed by an NE (e.g., a sensing entity), as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity (NE) for wireless communication, comprising:
at least one memory; and
at least one processor coupled with the at least one memory and operable to cause the first NE to:
obtain a request to trigger a sensing operation associated with a sensing target, wherein the request comprises one or more parameters associated with a sensing accuracy of the sensing operation;
output, to a second NE, the request with an update to the one or more parameters to satisfy a privacy criteria associated with the sensing target, wherein the privacy criteria indicates a threshold value associated with the sensing accuracy; and
obtain, based at least in part on the update to the one or more parameters, one or more sensing measurements associated with the sensing target.

2. The first NE of claim 1, wherein the at least one processor is further operable to cause the first NE to obtain, from at least one of a local data storage associated with the first NE or an external data storage accessible by the first NE, the privacy criteria, wherein the privacy criteria are associated with at least one of a sensing area associated with the sensing target or a device associated with the sensing target, and wherein the request indicates the at least one of the sensing area or the device.

3. The first NE of claim 1, wherein the one or more parameters comprise a sensing accuracy parameter, and wherein the at least one processor is further operable to cause the first NE to modify the sensing accuracy parameter from a first accuracy value to a second accuracy value that is lower than the first accuracy value, wherein the update to the one or more parameters comprises the second accuracy value.

4. The first NE of claim 3, wherein the first accuracy value corresponds to a first resolution that enables identification of a type of the sensing target, and wherein the second accuracy value corresponds to a second resolution that disables the identification of the type of the sensing target.

5. The first NE of claim 1, wherein the request comprises a sensing target blueprint indicating a pattern of scattering points associated with the sensing target, and wherein the at least one processor is further operable to cause the first NE to:
determine that the sensing target blueprint is associated with a sensing accuracy value that fails to satisfy the threshold value prior to updating the one or more parameters; and
modify the sensing target blueprint, wherein the sensing accuracy value satisfies the threshold value based at least in part on modifying the sensing target blueprint, and wherein the one or more parameters comprise at least one of the pattern of the scattering points or the sensing accuracy value.

6. The first NE of claim 1, wherein the at least one processor is further operable to cause the first NE to:
determine, based at least in part on the update to the one or more parameters, that the one or more sensing measurements satisfy the privacy criteria; and
output, to a third NE and based at least in part on the one or more sensing measurements satisfying the privacy criteria, the one or more sensing measurements and an indication that the privacy criteria are satisfied, wherein the third NE comprises a network exposure function (NEF).

7. The first NE of claim 1, wherein the at least one processor is further operable to cause the first NE to:
obtain, from a third NE, an additional request to trigger an additional sensing operation associated with an additional sensing target, wherein the third NE comprises a network exposure function (NEF); and
output, to the third NE, an indication that the additional request is rejected based at least in part on additional privacy criteria associated with the additional sensing target.

8. The first NE of claim 1, wherein the privacy criteria are associated with a geographic area defined by at least one of an antenna tilt range associated with the second NE or an angular range associated with the second NE.

9. The first NE of claim 1, wherein the privacy criteria are based at least in part on one or more of a user consent associated with the sensing target, a geographic location associated with the sensing target, one or more legal policies associated with the sensing target, one or more operator policies associated with the sensing target, or a timing associated with the sensing operation.

10. The first NE of claim 1, wherein the first NE comprises a sensing function, and wherein the second NE comprises a sensing entity.

11. A method performed by a first network entity (NE), the method comprising:
obtaining a request to trigger a sensing operation associated with a sensing target, wherein the request comprises one or more parameters associated with a sensing accuracy of the sensing operation;
outputting, to a second NE, the request with an update to the one or more parameters to satisfy a privacy criteria associated with the sensing target, wherein the privacy criteria indicates a threshold value associated with the sensing accuracy; and
obtaining, based at least in part on the update to the one or more parameters, one or more sensing measurements associated with the sensing target.

12. A first network entity (NE) for wireless communication, comprising:
at least one memory; and
at least one processor coupled with the at least one memory and operable to cause the first NE to:
obtain a request to trigger a sensing operation associated with a sensing target, wherein the request comprises one or more parameters associated with a sensing accuracy of the sensing operation;
perform, based at least in part on an update to the one or more parameters, the sensing operation to obtain one or more sensing measurements, wherein the update to the one or more parameters satisfies a privacy criteria associated with the sensing target, and wherein the privacy criteria indicates a threshold value associated with the sensing accuracy;
and output, based at least in part on the request, the one or more sensing measurements and an indication that the privacy criteria are satisfied.

13. The first NE of claim 12, wherein the at least one processor is further operable to cause the first NE to obtain, from at least one of a local data storage associated with the first NE or an external data storage accessible by the first NE, the privacy criteria, wherein the privacy criteria are associated with a sensing area associated with the sensing target.

14. The first NE of claim 12, wherein the one or more parameters comprise a sensing accuracy parameter, and wherein the at least one processor is further operable to cause the first NE to modify the sensing accuracy parameter from a first accuracy value to a second accuracy value that is lower than the first accuracy value, wherein the update to the one or more parameters comprises the second accuracy value.

15. The first NE of claim 14, wherein the first accuracy value corresponds to a first resolution that enables identification of a type of the sensing target, and wherein the second accuracy value corresponds to a second resolution that disables the identification of the type of the sensing target.

16. The first NE of claim 12, wherein the request comprises a sensing target blueprint indicating a pattern of scattering points associated with the sensing target, and wherein the at least one processor is further operable to cause the first NE to:
determine that the sensing target blueprint is associated with a sensing accuracy value that fails to satisfy the threshold value prior to updating the one or more parameters; and
modify the sensing target blueprint, wherein the sensing accuracy value satisfies the threshold value based at least in part on modifying the sensing target blueprint.

17. The first NE of claim 12, wherein the at least one processor is further operable to cause the first NE to:
obtain an additional request to trigger an additional sensing operation associated with an additional sensing target; and
output an additional indication that the additional request is rejected based at least in part on additional privacy criteria associated with the additional sensing target.

18. The first NE of claim 12, wherein the privacy criteria are associated with a geographic area defined by at least one of an antenna tilt range associated with the first NE or an angular range associated with the first NE.

19. The first NE of claim 12, wherein the privacy criteria are based at least in part on one or more of a user consent associated with the sensing target, a geographic location associated with the sensing target, one or more legal policies associated with the sensing target, one or more operator policies associated with the sensing target, or a timing associated with the sensing operation, and wherein the first NE comprises a sensing entity.

20. A method performed by a first network entity (NE), the method comprising:
obtaining a request to trigger a sensing operation associated with a sensing target, wherein the request comprises one or more parameters associated with a sensing accuracy of the sensing operation;
performing, based at least in part on an update to the one or more parameters, the sensing operation to obtain one or more sensing measurements, wherein the update to the one or more parameters satisfies a privacy criteria associated with the sensing target, and wherein the privacy criteria indicates a threshold value associated with the sensing accuracy; and
outputting, based at least in part on the request, the one or more sensing measurements and an indication that the privacy criteria are satisfied.
